(19) United States
(12) Patent Application Publication
(10) Pub. No.: US 2020/0042656 A1
(43) Pub. Date: Feb. 6, 2020

(54) SYSTEMS AND METHODS FOR PERSISTENT SIMULATION

(71) Applicant: Toyota Research Institute, Inc., Los Altos, CA (US)

(72) Inventors: Samuel Zapolsky, San Francisco, CA (US); Evan Drumwright, Mountain View, CA (US); Arshan Poursohi, Berkley, CA (US)

(21) Appl. No.: 16/050,406

(22) Filed: Jul. 31, 2018

(51) Int. Cl. G06F 17/50; G06K 9/00

(52) U.S. Cl. CPC G06F 17/5009; G06K 9/00624

(57) ABSTRACT

System, methods, and other embodiments described herein relate to improving persistent simulation of an environment. In one embodiment, a method includes capturing, using at least one sensor, state information about the environment that is proximate to a robotic device. The state information includes data about at least one object that is in the environment. The method includes generating a simulation of the environment according to at least a simulation model and characteristics of the at least one object identified from the state information. The simulation is a virtualization of the environment that characterizes the at least one object in relation to an inertial frame of the environment around the observing robotic device. The method includes predicting a subsequent state for the at least one object within the simulation based, at least in part, on the simulation model. The method includes providing the subsequent state as an electronic output.

### TECHNICAL FIELD

The subject matter described herein relates in general to systems and methods for simulating objects within an environment and, more particularly, to generating a persistent simulation using motion capture.

### BACKGROUND

Machine perception and understanding of a surrounding environment can represent a difficult task. For example, robots generally use electronic sensors such as cameras, LiDAR, and other sensors to acquire information about a surrounding environment. The information can take different forms such as still images, video, point clouds, and so on. Understanding the contents of the information, and determining meaningful information therefrom can be difficult.

By way of example, the robots generally process the information in order to provide for making determinations about the presence of objects, the motion of the objects, and so on. However, because the robot may not fully understand dynamic behaviors of different types of objects and because these determinations are made in real-time in relation to the perceived objects, extrapolated movements of the objects may be uncertain. Moreover, interactions between objects and awareness of the objects when not directly perceived can also present difficulties in relation to how the robot predicts and simulates the behaviors.

### SUMMARY

In one embodiment, example systems and methods relate to a manner of using motion capture to generate a persistent simulation of an environment. For example, in one approach, a system captures data about a surrounding environment of a robot (e.g., autonomous vehicle, a humanoid robot, etc.). In various aspects, the system captures the data using cameras and/or other environmental sensors. Moreover, objects in the environment, in one embodiment, are marked with fiducials in order to promote tracking of the particular objects and dynamic behaviors associated therewith. As such, while the general focus is on perceptions by the robot, sensors on the robot, and/or mounted within the environment may be leveraged in order to acquire data about the objects.

Accordingly, the system captures the data that includes observations of one or more objects in the surrounding environment. The data generally includes state information that characterizes physical attributes of the object(s) and motion of the object(s) in relation to the robot. From the state information, the system, in one aspect, generates a simulation of the object(s) in the surrounding environment. The simulation is, for example, a physically accurate virtual reconstruction of the surrounding environment including representations of the objects that the system generates at time steps that are quicker than real-time to provide for anticipating motion of the objects within the surrounding environment.

Thus, the system, in one embodiment, uses the simulation as a manner of predicting movements and interactions between the objects therein. For example, the system can predict a subsequent state of a detected object according to a simulation model that characterizes expected movements and a form of the movements according to a present state and/or potential interactions from the robot. This ability to accurately predict subsequent states of the objects (e.g., subsequent movements) that follow a present state acquired from currently perceived information further permits the system to generate the simulation in a persistent manner for the detected object even when subsequent acquisitions of information do not include the previously detected object. Thus, when the system initially detects the object and generates the simulation to include the object and predictions of a subsequent state of the object, the system can then further extrapolate the prediction to maintain awareness of the object even when the object is not necessarily perceived in a subsequent acquisition of information. In this way, the system improves awareness of aspects of the environment by the robot when those aspects are not directly perceived.

Furthermore, as the system captures subsequent information that does embody further state information about the detected objects, the system uses the subsequently perceived information to improve predictions. That is, for example, the system compares the predicted subsequent state with a presently perceived state from the presently captured information. In one embodiment, the comparison can provide for updating the present representation in the simulation to correspond with the actual state of the object and/or improving/updating the simulation model to reflect actual perceived dynamic behaviors of the object. In this way, the system improves how the simulation is generated and also how the robot understands the surrounding environment and objects therein.

In one embodiment, a simulation system for improving predictions about dynamic behaviors within an environment is disclosed. The simulation system includes one or more processors and a memory communicably coupled to the one or more processors. The memory storing a capture module including instructions that when executed by the one or more processors cause the one or more processors to capture, using at least one sensor, state information about the environment that is proximate to an observing robotic device. The state information includes data about at least one object that is in the environment. The memory storing a simulation module including instructions that when executed by the one or more processors cause the one or more processors to generate a simulation of the environment according to at least a simulation model and characteristics of the at least one object identified from the state information. The simulation characterizes the at least one object in relation to an inertial frame of the environment around the observing robotic device. The simulation module further includes instructions to predict a subsequent state for the at least one object within the simulation based, at least in part, on the simulation model, and to provide the subsequent state as an electronic output.

In one embodiment, A non-transitory computer-readable medium for improving predictions about dynamic behaviors within an environment is disclosed. The non-transitory computer-readable medium including instructions that when executed by one or more processors cause the one or more processors to perform various functions. The instructions include instructions to capture, using at least one sensor, state information about the environment that is proximate to an observing robotic device. The state information includes data about at least one object that is in the environment. The instructions include instructions to generate a simulation of the environment according to at least a simulation model and characteristics of the at least one object identified from the state information. The simulation characterizes the at least one object in relation to an inertial frame of the environment around the observing robotic device. The instructions including instructions to predict a subsequent state for the at least one object within the simulation based, at least in part, on the simulation model. The instructions including instructions to provide the subsequent state as an electronic output.

In one embodiment, a method for improving a persistent simulation of an environment is disclosed. In one embodiment, a method includes capturing, using at least one sensor, state information about the environment that is proximate to an observing robotic device. The state information includes data about at least one object that is in the environment. The method includes generating a simulation of the environment according to at least a simulation model and characteristics of the at least one object identified from the state information, wherein the simulation is a virtualization of the environment that characterizes the at least one object in relation to an inertial frame of the environment around the observing robotic device. The method includes predicting a subsequent state for the at least one object within the simulation based, at least in part, on the simulation model. The method includes providing the subsequent state as an electronic output.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a simulation system that is associated with capturing a current state of an environment and predicting a subsequent state.

FIG. 3 illustrates one embodiment of a method associated with predicting dynamic behaviors of objects within an environment.

FIG. 4 illustrates one embodiment of an example environment within which the present systems and methods may operate.

FIG. 5 illustrates one example of a scene graph that represents the environment depicted in FIG. 4.

### DETAILED DESCRIPTION

Systems, methods and other embodiments associated with using motion capture techniques to improve simulation of objects in an environment are disclosed. As mentioned previously, understanding dynamic behaviors and potential future movements/reactions of objects (e.g., rigid-body objects) in a surrounding environment can be a complex task. Additionally, a device, such as an autonomous vehicle or other robotic device, can encounter instances where perceptions of objects are interrupted when the objects pass out of a field-of-view of a particular sensor. Thus, the device may not always have a complete observation and awareness of the environment. Moreover, planning autonomous movements can encounter additional complexity when dynamic behaviors of objects are unknown or otherwise not precisely predictable.

Therefore, in one embodiment, a disclosed simulation system improves the noted aspects by simulating an environment around the device while using motion capture techniques to facilitate with tracking objects in the environment. For example, in one approach, a system captures data about a surrounding environment of the device using one or more electronic sensors such as cameras. In various aspects, the cameras can be onboard cameras of the device itself, infrastructure types of cameras mounted within the environment (e.g., indoor wall-mounted cameras, outdoor telephone pole mounted, etc.), or a combination of the two. Moreover, objects in the environment, in one embodiment, are marked with fiducials in order to promote tracking of the particular objects and dynamic behaviors associated therewith. The fiducials can be explicit markers located on different surfaces of the objects, electronic sensors (e.g., RFID), or another form of marker for tracking objects. In further aspects, the objects may be free of explicit visual or other markers and are instead tracked using various image recognition and tracking techniques.

As such, sensors on the robot, and/or mounted within the environment may be leveraged in order to acquire data about the objects. Accordingly, the simulation system captures the data that includes observations of one or more objects in the surrounding environment. The data is state information that generally characterizes physical attributes of the object(s) and motion of the object(s) in relation an inertial frame of the surrounding environment of the robot. Thus, the inertial frame, in one embodiment, is constant within the environment and not necessarily in relation to the robot itself. The simulation system can utilize the fiducial markers to facilitate tracking the object(s) and determining aspects related to the object(s) according to motion capture techniques that reference the fiducial markers. For example, from the state information, the simulation system, in one aspect, generates a simulation of the object(s) in the surrounding environment. The simulation is, for example, a virtualization of the surrounding environment that is a physically accurate representation including the object(s). Furthermore, the simulation system generates the simulation at time steps that are faster than real-time to provide for anticipating motion and interactions with the object(s) within the surrounding environment.

Thus, the simulation system generally uses the simulation as a manner of predicting movements and interactions between the objects therein. For example, the system can predict a subsequent state of a detected object according to a simulation model that characterizes expected movements and a form of the movements according to a present state and/or potential interactions from the robot. This ability to accurately predict subsequent states of the objects (e.g., subsequent movements) that follow a present state further permits the system to generate the simulation in a persistent manner for the detected object. When the simulation system initially detects the object and generates the simulation with the object, the simulation system also predicts a subsequent state of the object. Consequently, the simulation system uses the simulation model to then further extrapolate the prediction to maintain awareness of the object when the object is not perceived in a subsequent acquisition of information. In this way, the simulation system improves awareness of aspects of the environment by the robot even when those aspects are not observed.

Furthermore, as the simulation system captures subsequent information that does embody further state information about the detected objects, the simulation system uses the subsequently perceived information to improve the simulation model. That is, for example, the simulation system compares the predicted subsequent state with a presently perceived state from the presently captured information. In one embodiment, the simulation system uses identified differences between the predicted information and the perceived information as a means for updating the present representation in the simulation to correspond with the actual state of the object. In further aspects, the simulation system uses the identified differences to improve the simulation model itself by updating internal attributes of modeling algorithms and/or updating/changing the algorithms themselves to better reflect actual perceived dynamic behaviors of the objects. In this way, the simulation system improves how the simulation model is configured and thus how the simulation system generates the simulation. As a further extension of the noted improvements, the robot can better understand the surrounding environment and how objects may dynamically behave therein so that movements and actions of the robot can better account for the behaviors.

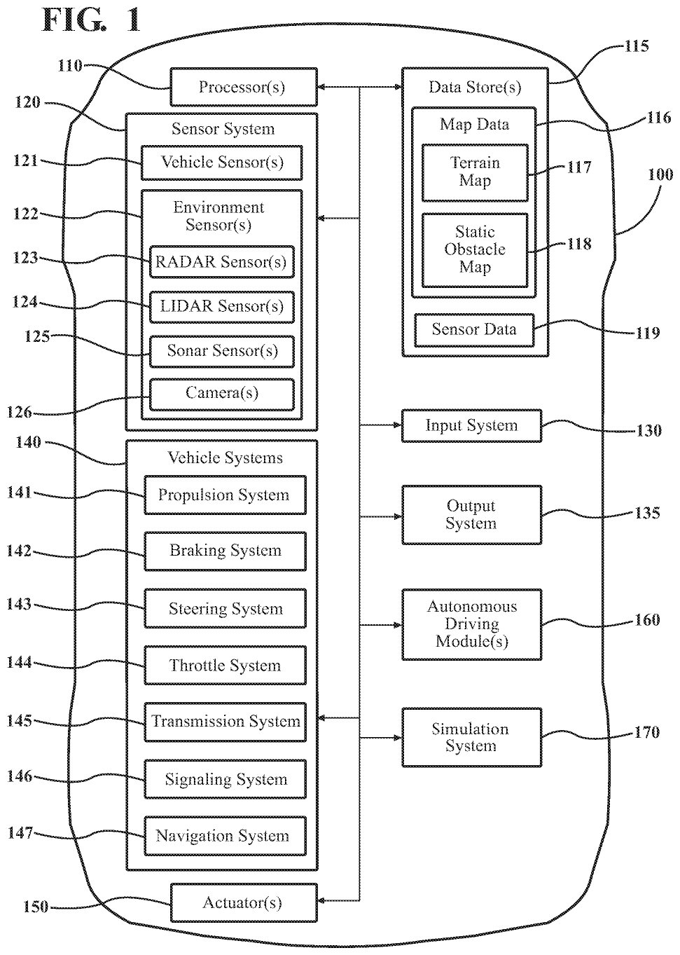

Referring to FIG. 1, an example of a vehicle 100 is illustrated. As used herein, a “vehicle” is any form of motorized transport. In one or more implementations, the vehicle 100 is an automobile. While an arrangement illustrated in FIG. 1 is generally shown as an automobile, it will be understood that embodiments are not limited to automobiles. In some implementations, the vehicle 100 may be any robotic device that, for example, can operate autonomously or at least semi-autonomously and captures data from sensors to perceive objects and other aspects of a surrounding environment as discussed herein. Accordingly, in further aspects, the vehicle 100 may instead be a humanoid-type of robot, a service robot, an articulated arm, or, more generally any robotic device that benefits from the systems and methods disclosed herein.

In either case, as illustrated, the vehicle 100 includes various elements. It will be understood that in various embodiments it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100 or remote from the vehicle 100 as a cloud-based service. Further, the elements shown may be physically separated by large distances.

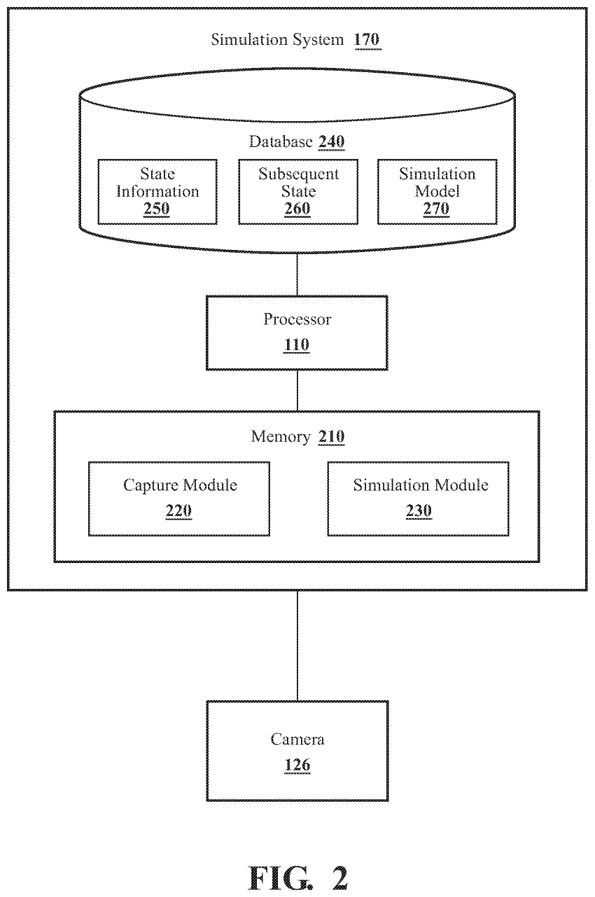

Some of the possible elements of the vehicle 100 are shown in FIG. 1 and will be described along with subsequent figures. However, a description of many of the elements in FIG. 1 will be provided after the discussion of FIGS. 2-5 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

In either case, the vehicle 100 includes, in one embodiment, a simulation system 170 that is implemented to perform methods and other functions as disclosed herein relating to using an end-to-end model to pre-train sub-modules for autonomous driving tasks. It should be appreciated, that while the simulation system 170 is illustrated as being a part of the vehicle 100, in various embodiments, the simulation system 170 is a separate component from the vehicle 100 that can be provided as a centralized server, a cloud-based service, and so on. The noted functions and methods will become more apparent with a further discussion of the figures.

With reference to FIG. 2, one embodiment of the simulation system 170 of FIG. 1 is further illustrated. The simulation system 170 is shown as including a processor 110 from the vehicle 100 of FIG. 1. Accordingly, the processor 110 may be a part of the simulation system 170, the simulation system 170 may include a separate processor from the processor 110 of the vehicle 100, or the simulation system 170 may access the processor 110 through a data bus or another communication path. In one embodiment, the simulation system 170 includes a memory 210 that stores a capture module 220 and a simulation module 230. The memory 210 is a random-access memory (RAM), read-only memory (ROM), a hard-disk drive, a flash memory, or other suitable memory for storing the modules 220 and 230. The modules 220 and 230 are, for example, computer-readable instructions that when executed by the processor 110 cause the processor 110 to perform the various functions disclosed herein. Moreover, it should be appreciated that while the simulation system 170 is illustrated as being wholly embodied within the vehicle 100, in various embodiments, one or more aspects of the simulation system 170 are implemented as cloud-based services, centralized OEM services, and so on.

In either case, in one embodiment, the capture module 220 generally includes instructions that function to control the processor 110 to capture state information 250 about an environment that is proximate to a robotic device (e.g., the vehicle 100). The environment (also referred to as surrounding environment herein) is an area that is proximate to the observing robotic device (e.g., the vehicle 100) and that the observing robotic device may travel through, interact with, modify and so on. Additionally, it is generally understood that the environment includes at least one object. However, it should be appreciated that the environment will generally include a plurality of objects that are separately analyzed and tracked by the simulation system 170. Moreover, the environment can be a pre-configured environment that includes objects with fiducial markers for facilitating tracking. As used herein, fiducial markers should be understood to include visual markings or instrumentation that is added to an object and is useful for at least tracking the object using a sensor such as a camera. The exact form of the fiducials can vary according to a particular implementation but generally include distinctive visual reference points on one or more surfaces of marked objects. The fiducial markers generally simplify the task of tracking an object and aspects about the object such as a particular pose, dimensions, movements between data acquisitions, (e.g., horizontal, vertical, rotational), and so on.

As a further aspect, the environment itself can be, in various implementations, a motion capture environment that is outfitted with one or more sensors (e.g., one or more cameras) for motion capture or for other purposes but that are repurposed by the capture module 220 for capturing the state information 250. Thus, the capture module 220 in one embodiment, uses sensors within the environment, and within the observing robotic device to capture the state information 250. Of course, in further aspects, the environment does not include separate sensors to capture the state information 250, and instead, the capture module 220 controls onboard sensors to acquire the information. Similarly, the objects, in one approach, are not outfitted with fiducial markers and instead the capture module 220 relies on image recognition algorithms to track the objects.

In either case, the capture module 220 captures the state information 250 about the surrounding environment. The state information 250 includes, in one embodiment, observations about various aspects of the surrounding environment in which the vehicle 100 is presently positioned. Thus, the state information 250 generally includes observations of one or more objects, obstacles, walls, buildings, roadway features, and/or other aspects about the surroundings that are encountered by the vehicle 100 and for which information is generally useful when proceeding through the environment.

Additionally, as provided for herein, the capture module 220 receives sensor data from, for example, at least the camera 126. The capture module 220, in various embodiments, also receives additional information as part of the state information 250 such as camera images from remote sensors, information from instrumentation within an object that is being tracked, inertial information from the vehicle 100, and so on. As a further aspect, the capture module 220 can employ one or more motion capture techniques to track and/or provide information about the objects. For example, the capture module 220 implements motion capture techniques to track fiducial markers on the objects and to determine therefrom such information as speed, rotational velocity, relative movements, dimensions, and so on.

Accordingly, in one embodiment, the simulation system 170 includes the database 240 as a means of storing various data elements. The database 240 is, in one embodiment, an electronic data structure stored in the memory 210 or another electronic data store and that is configured with routines that can be executed by the processor 110 for analyzing stored data, providing stored data, organizing stored data, and so on. Thus, in one embodiment, the database 240 stores data used by the modules 220 and 230 in executing various functions. In one embodiment, the database 240 includes the noted state information 250, subsequent states 260, a simulation model 270, and/or other information that is used by the modules 220 and/or 230. As an additional note, while the simulation model 270 is discussed as being stored in the database 240, of course, in various implementations various data structures, logic, and other aspects of the simulation model 270 are integrated with the simulation module 230.

Additionally, while the state information 250 and other data elements may be discussed from the perspective of a single acquisition, it should be appreciated that the capture module 220, in one embodiment, updates data elements such as the state information 250 through iterative data acquisitions over time in order to provide for iteratively performing the noted functions discussed herein. Thus, the singular acquisition is discussed as a manner of explaining the presently disclosed systems. Accordingly, the capture module 220, in one embodiment, acquires the state information 250 to initially detect objects and aspects of the environment as the vehicle 100 proceeds and also as a manner of acquiring subsequent state information to subsequently track previously detected objects and aspects of the surrounding environment to, for example, maintain an awareness of the environment.

Moreover, the capture module 220, in one embodiment, analyzes the state information 250 to determine characteristics of objects present therein. In one aspect, the capture module 220 analyzes the state information 250 by segmenting the objects from the state information 250, localizing the objects in the environment, estimating a pose, a velocity, and/or other information about the objects, which is generally useful in understanding movements and relationships of the objects to the observing robotic device (e.g., the vehicle 100). Thus, the capture module 220 acquires the state information 250 to locate the object in the environment, determine a general size and shape of the object, determine present motion of the object, and so on. In further aspects, the capture module 220 uses one or more of the data elements to produce further inferences about the object such as a mass of the object, and/or other useful information.

In either case, the acquired and processed state information 250 is employed by the simulation module 230 to produce a simulation of the environment. That is, in one embodiment, the simulation module 230 generally includes instructions that function to control the processor 110 to generate a simulation of the environment according to the simulation model 270 and the characteristics previously determined from the state information 250. The simulation itself is an abstract reconstruction of the environment that characterizes objects therein and relationships between the objects. In particular, the simulation characterizes relationships between the observing robotic device (e.g., the vehicle 100) and the objects.

The simulation module 230, in one aspect, generates the simulation in a persistent manner so as to maintain an awareness of objects that have been detected. For example, the simulation module 230 includes a representation of objects detected by the capture module 220 including relative locations, speeds, sizes, etc. for those objects. Moreover, the simulation module 230 uses the simulation model 270 to populate the simulation with the objects according to the state information 250. Thus, the simulation is generally a virtualization of the current state of the objects and other aspects of the environment.

As such, the simulation module 230 can use the simulation to predict a subsequent state of an object and to provide an awareness of potential movements of the objects in relation to current states of movement or poses. That is, the simulation module 230 uses the embodiment of the environment as represented in the simulation to estimate a location, orientation, and other characteristics of objects at future points in time. For example, when the environment includes a ball perched on the edge of a table, the simulation module 230 generates the simulation with representations of the noted objects and predicts a subsequent state or states of the ball according to extrapolated movements thereof. Thus, the simulation module 230 predicts a subsequent state for the ball rolling off of the table and bouncing off of the floor. In one embodiment, the simulation module 230 predicts this movement according to a perceived motion of the ball toward the edge of the table. Thus, the simulation module 230 predicts the subsequent state according to a controlling subset of models/algorithms within the simulation model 270 that indicate how the ball would roll and fall.

In further aspects, the simulation module 230 predicts the subsequent state(s) according to inquiries of an autonomous system (e.g., module 160) indicating potentially desired movements of the robotic device and possible interactions with the surrounding environment. In either case, the simulation module 230 provides the predicted subsequent state as an electronic output. For example, the simulation module 230 provides the predicted subsequent state of each object as an electronic output in a list format or other format that includes coordinates of predicted positions, speed, pose, and so on. In further aspects, the simulation module 230 provides electronic outputs about salient objects (e.g., moving objects, objects about to collide with the vehicle 100, etc.). Moreover, in various embodiments, the simulation module 230 provides the subsequent state 260 as electronic outputs to path planning, obstacle detection, and/or other autonomous operation modules (e.g., autonomous driving module 160).

With further reference to the simulation model 270 itself, the simulation model 270 is generally comprised of various sub-models that characterize different categories of objects and circumstances that may arise in the simulation. In various embodiments, the simulation model 270 can be implemented according to different machine learning algorithms. For example, the simulation model 270 can be a deep learning algorithm of a particular type or a hybrid combination of networks. In further aspects, the simulation model 270 is a collection of parametric algorithms, relational algorithms, and so on. Thus, the simulation model 270 includes, in one embodiment, a plurality of algorithms that include parameters such as weighting factors, constants, coefficients, and so forth that define how the simulation represents objects and how the simulation module 230 predicts subsequent states. In general, the simulation model 270 is not limited to a particular algorithmic approach but is instead intended to encompass one or more algorithms that describe traits, motion, and interactions of the various objects according to a known set of rules (e.g., classic mechanics).

Moreover, in addition to predicting the subsequent state of an object using the simulation model 270, the simulation module 230 tracks the objects in a persistent manner. For example, when the capture module 220 does not subsequently observe an object for which the simulation module 230 generates a representation in the simulation and predicts a subsequent state, the simulation module 230 can continue to persistently simulate the object through extrapolating a location, speed, etc. of the object within the simulation. By generating further predictions about the object even though unobserved, the simulation system 170 can provide for tracking the object through an estimation/prediction of a subsequent location/speed. Thus, the simulation module 230 can assist the robotic device (e.g., the vehicle 100) with maintaining an awareness of objects even when those objects are not within a field-of-view of a sensor and thus go unobserved. The robotic device can then extend this knowledge of the unobserved objects to subsequent planning in relation to when the object may again be encountered, potential interactions of the unobserved object with other objects that may impact the robotic device, and so on.

As an additional aspect, in one embodiment, the simulation module 230 compares the predicted subsequent state 260 for an object with a perceived state as embodied by state information 250 that is captured subsequent to the simulation module 230 predicting the subsequent state 260. That is, because the capture module 220 is iteratively capturing additional state information 250, the predictions about a subsequent state 260 of the object can be compared against the perceived information at a later time step. Accordingly, the simulation module 230 compares the subsequent state 260 for the object as previously predicted to a perceived state identified from a current acquisition of the state information 250 via current images or other sensor data. Thus, the current acquisition of the state information 250 provides for a comparison to determine an actual state (e.g., location, speed, etc.) of the object and also a frame of reference to determine how well the simulation module 230 generated the simulation.

In either case, the simulation module 230 can use identified differences from the comparison to, for example, update a representation of the object within the simulation and/or to update the simulation model 270. That is, when the simulation module 230 determines that the object, as represented within the simulation, differs from, for example, an actual location of the object as observed via the sensors, the simulation module 230 adjusts the representation within the simulation to correspond with the known location.

In further aspects, the simulation module 230 uses the identified differences to improve the simulation model 270. For example, the simulation module 230 analyzes the differences to determine an amount of error between the predicted subsequent state 260 and the perceived state at the subsequent time step. The simulation module 230, in one approach, then assesses values that would provide the perceived state in relation to the parameters (e.g., coefficients, constants, etc.) of the algorithms within the model 270. Accordingly, the simulation module 230 can then adjust the parameters to improve the model 270. In further aspects, the simulation module 230 adjusts underlying equations/algorithms of the model 270 to improve how the simulation module 230 generates the simulation. For example, the simulation module 230 adds additional factors to one or more equations to account for the discrepancies. Alternatively, or additionally, the simulation module 230 employs a machine learning algorithm that actively performs the comparison for each acquisition of data and back-propagates the indicated error so that the machine learning algorithm can adjust internal nodal weights or other aspects of how the prediction is made. In either case, the simulation module 230 provides for improving the simulation model 270 through comparing predicted states with state information that is subsequently acquired and which corresponds to the predicted states.

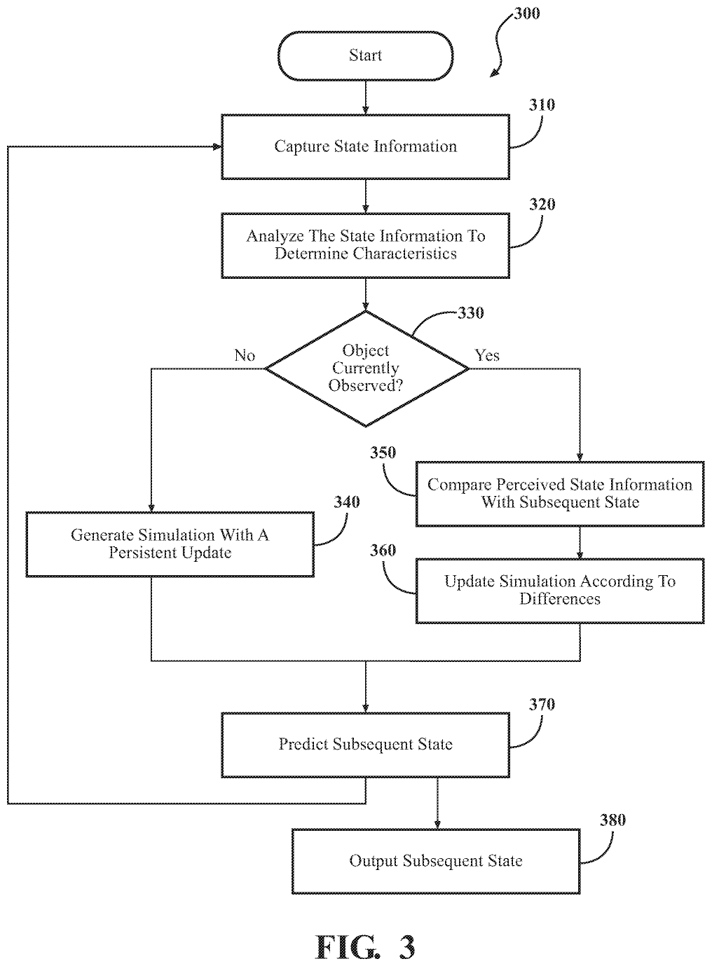

Additional aspects of generating a simulation of a surrounding environment will be discussed in relation to FIG. 3. FIG. 3 illustrates a flowchart of a method 300 that is associated with using motion capture techniques to improve simulation of objects in an environment. Method 300 will be discussed from the perspective of the simulation system 170 of FIGS. 1 and 2. While method 300 is discussed in combination with the simulation system 170, it should be understood that the method 300 is not limited to being implemented within the simulation system 170, but is instead one example of a system that may implement the method 300.

Moreover, as an initial matter, it should be appreciated that the following method 300 and the associated flowchart of FIG. 3 are discussed from the perspective of the noted simulation having been previously initialized by the simulation system 170 with at least one object previously detected that is included therein. For example, the simulation system 170 initially generates a simulation of the environment according to the simulation model 270 and characteristics of the at least one object identified from the state information 250. Thus, upon initial acquisition of information about the at least one object, the simulation module 230 adds the object into the simulation and may then perform persistent simulation of the object and/or use the object as a reference to update the simulation model 270 as discussed in relation to method 300.

At 310, the capture module 220 captures the state information 250 about the environment. As previously indicated, the capture module 220 can capture the state information 250 from cameras (e.g., camera 126) that are onboard the robotic device, mounted within the environment, communicated from other mobile devices, and/or a combination thereof. In general, the capture module 220 acquires the state information 250 about the environment iteratively in order to acquire and maintain awareness about a current state of objects in the environment and a location of the robotic device in the environment. Thus, the capture module 220, in various embodiments, captures the state information 250 at successive time steps that are generally sufficient to track movements of the objects and determine changes to a path through the environment as the robotic device moves. In one embodiment, the capture module 220 acquires the images at, for example, 30 frames per second. Thus, the capture module 220 can provide iterative updates to the state information 250 while the simulation module 230 iteratively updates the simulation in parallel.

Moreover, as previously indicated, the capture module 220 can implement one or more motion capture techniques to facilitate tracking and determining information about the at least one object. Thus, the capture module 220, in one aspect, uses motion capture techniques to track fiducial marker of objects between successive frames and to extrapolate motion data (e.g., speed, position, etc.) therefrom. In this way, the capture module 220 improves an accuracy with which the objects are tracked and can thus improve determinations made therefrom.

At 320, the capture module 220 analyzes the state information 250 to determine characteristics of the object. In one embodiment, the capture module 220 applies a deep learning algorithm (e.g., convolutional neural network) to the images in order to identify objects therein, segment objects from the images, localize the objects in the environment, estimate a pose, a velocity, a size, a mass, and/or other aspects of the objects. As a further aspect, as part of analyzing the state information 250, the capture module 220 can execute the noted motion capture techniques using the state information 250 to detect visible fiducial markers that facilitate determining at least some of the characteristics. For example, the capture module 220 can use the fiducial markers to determine current 3D positions in the environment, facilitate tracking the object between successive images, and to more precisely determine movements such that a pose, and speed may be determined with improved clarity. In either case, the capture module 220 provides the characteristics to the simulation module 230 so that the simulation module 230 can process the characteristics using the simulation model 270 and generate the simulation.

At 330, the simulation module 230 determines whether an object represented in the simulation is presently observed in the station information 250. If the simulation module 230 determines that the object represented in the simulation does not correspond to a present observation in the state information 250, then the simulation module 230 proceeds to generate a persistent update as discussed along with block 340. However, if the simulation module 230 determines that the object is present within the presently observed state information, then the simulation module 230 proceeds by comparing the perceived information with the previously predicted subsequent state as discussed along with block 350.

At 340, the simulation module 230 generates a persistent update to the simulation that predicts an unobserved state of the object. In one embodiment, the simulation module 230 updates the predicted subsequent state for an object when the object is not observed but was previously observed and is represented in the simulation. For example, if the object passes out of a field-of-view of sensors that are observing the environment and providing the state information 250, then the capture module 220 does not acquire additional information about the object and cannot provide updated characteristics for a subsequent time step that corresponds with the predicted subsequent state 260.

Accordingly, in one embodiment, the simulation module 230 extrapolates the previously predicted subsequent state 260 to provide a persistent update to the simulation that characterizes an expected current state even though the object has not been observed. Thus, in one approach, the simulation module 230 uses previously captured information, the previously predicted subsequent state 260, and the simulation model 270 to generate the persistent update. As previously noted, the persistent updates provided to the simulation for unobserved objects, facilitates maintaining an awareness about objects in the environment that may still be encountered by the robotic device. Thus, even though the object may not be directly observed, in a similar manner as a human may infer the presence of an object, the simulation module 230 provides for inferring the presence of the unobserved object through the persistent update. That is, the simulation module 230 extrapolates the movements of the previously observed object in a manner consistent with the previously observed motion and such that the simulation system 170 may continue to simulate the object until re-acquisition of an observation thereof.

At 350, the simulation module 230 compares the subsequent state 260 that was previously predicted with a perceived state identified within subsequent state information 250. The simulation module 230 identifies differences between the subsequent state and the perceived state that are indicative of discrepancies in the simulation model 270. For example, the simulation module 230 can compare a predicted location versus a perceived location, a predicted speed versus a perceived speed, and so on. Thus, the simulation module 230 can generally identify a plurality of differences between different aspects of the predicted subsequent state 250 and the perceived state. In further aspects, the simulation module 230 may normalize or otherwise process the differences to further quantify an error or disparity between the prediction and the actual perceived state. In either case, the identified differences can then be employed as discussed along with block 360.

At 360, the simulation module 230 updates the simulation model 270 according to the differences. In one embodiment, the simulation module 230 simply updates the simulation to reflect the perceived information when the comparison indicates a difference. That is, the simulation module 230 alters or otherwise adjusts a representation of the object in the simulation to correspond with the perceived information. In this way, the simulation can be corrected when predictions of subsequent states result in inaccurate representations.

In further aspects, the simulation module 230 can leverage the identified differences to improve functioning of the simulation model 270 itself. As previously discussed, the simulation module 230, in one embodiment, alters an internal configuration of the simulation model 270 to correct for the identified differences. The simulation module 230 is generally configured to adjust the simulation model 270 in two different forms. The first form of adjusting includes simply altering parameters of the simulation model 270 that relate to how the simulation of the object is generated. For example, the simulation model 270 can include a plurality of different equations that define dynamic behaviors of different types of objects, dynamic behaviors between objects, static behaviors, and so on. The separate equations generally include various coefficients and constants that control attributes of how the equations are executed by the simulation module 230 to simulate the aspects of the object.

Thus, in one approach, the simulation module 230 varies the noted coefficients and/or constants such that the predicted subsequent state 260 aligns with the perceived state. That is, the simulation module 230 can test various values until values that correct the predicted subsequent state are identified. Moreover, in one embodiment, if the simulation module 230 is unable to vary the noted values in a manner that approximates the perceived state through application of the simulation model 270, then the simulation module 230 can alter a configuration of the equation itself. That is, the simulation module 230 can add additional parameters, remove parameters, or simply substitute a different equation that better approximates the behaviors. In either case, the simulation module 230 may determine the appropriate course of action through trial and error, using a separate training algorithm (e.g., deep learning model), or through another suitable approach.

At 370, the simulation module 230 predicts a subsequent state for the object. In one embodiment, the simulation module 230 uses the state information 250 that is presently available to predict a pose of the object at a subsequent time step or steps. Thus, the simulation module 230 predicts the pose of the object to at least a next step in time, which generally correlates with a time at which further data is acquired, but may also predict the pose beyond a single time step out to a horizon of, for example, multiple seconds. While the prediction is discussed at 370 in regards to presently acquired information, the simulation module 230 performs a similar prediction at 340 for objects with no corresponding presently acquired information. Thus, at 370, the simulation module 230 may simply incorporate the predicted subsequent state for the unobserved objects into the simulation. In either case, the simulation module 230 uses the simulation model 270 to determine the subsequent state 260 of the objects in order to provide knowledge and inference to the robotic device so that the robotic device can plan according to possible changes in state of the objects as embodied by the predictions.

As a further matter, in one or more aspects, the robotic device actively manipulates the simulation through requests about different objects. For example, the robotic device may provide a planned manipulation or movement to the simulation module 230 to cause the simulation module 230 to interpolate the actions and predict subsequent states for the objects in the simulation according thereto. As one example that is further discussed subsequently, the robotic device may inquire about dynamic behaviors associated with moving a block that is supporting another block. In this case, the simulation module 230 accepts an input movement or series of movements representing the proposed action and, for example, predicts subsequent states 260 of the blocks within the simulation. In this way, the robotic device can determine effects associated with performing various actions in the environment.

At 380, the simulation module 230 provides the subsequent state 260 as an electronic output. In one embodiment, the simulation module 230 provides the subsequent state by formatting the subsequent state according to a protocol and electronically communicating the subsequent state to further modules within the robotic device (e.g., the vehicle 100). In this way, the simulation system 170 provides for improving simulation of objects while also improving inferences of the robotic device to account for potential dynamic behaviors of objects in the environment.

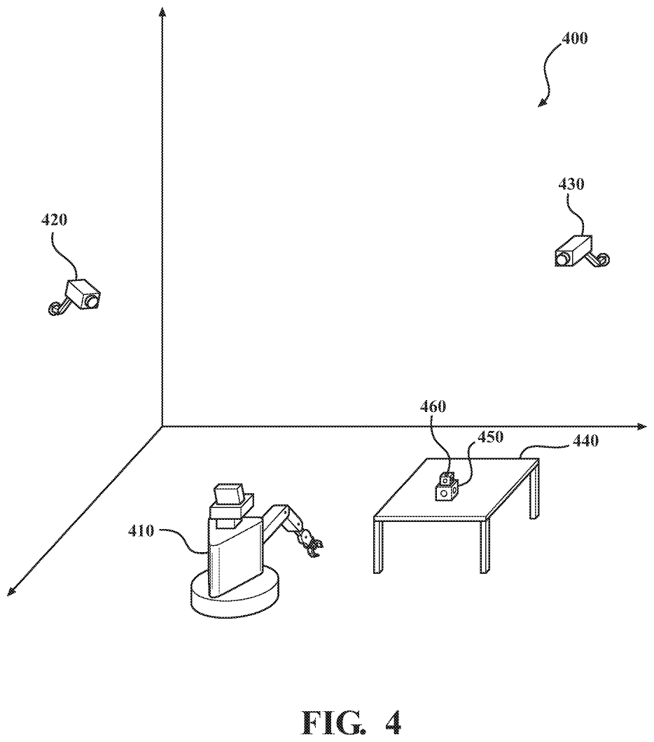

With reference to FIG. 4, one example of an environment 400 that is configured for motion capture is illustrated. As shown, the environment includes a robotic device 410 within which the simulation system 170 may be implemented. It should be noted that while the simulation system 170 is discussed as being integrated within the robotic device 410 or the vehicle 100, in various embodiments, the simulation system 170 may be located separately and remote from the robotic device 410. Thus, the simulation system 170 may electronically communicate with the robotic device 410 in such a case. Moreover, the environment further includes static cameras 420 and 430 with which the simulation system 170 communicates using wireless and/or wired communications. The robotic device 410 is situated proximate to a table 440 on which stacked blocks 450 and 460 are positioned. Additionally, the blocks 450 and 460 include visible fiducial markers on the surfaces. The cameras 420 and 430 acquire video of the environment 400 and track dynamic behaviors of the blocks 450 and 460 using the fiducial markers as the blocks 450 and 460 are perturbed.

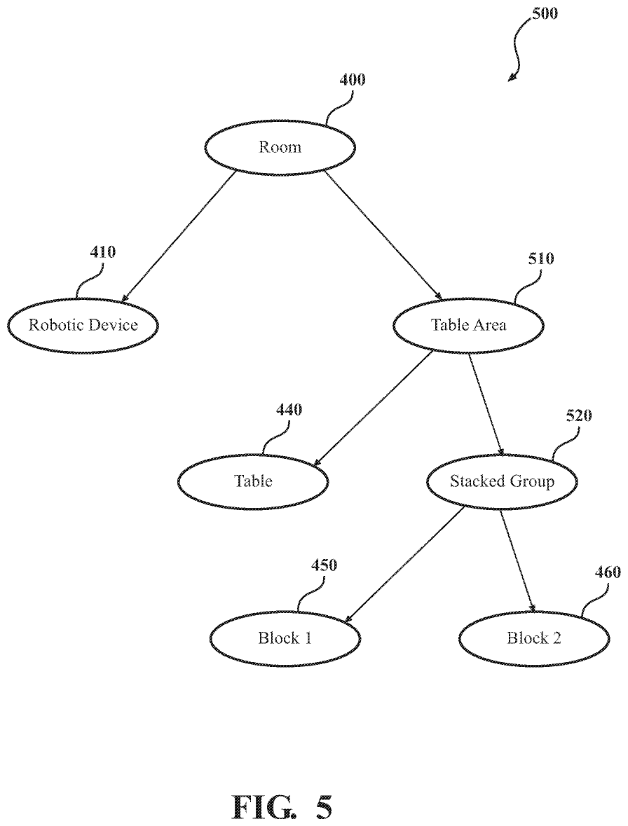

FIG. 5 illustrates an example scene graph 500 that is based on the environment 400 shown in FIG. 4. FIG. 5 is a graphical representation of how the simulation system 170, in one embodiment, represents objects within a simulation. Each node within the graph 500 represents an object or relationship to a group of objects. As shown, labels have been carried over from FIG. 4 to illustrate correlations. For example, a root node corresponds with a general area, which in this case is the room 400. Within the room 400 is the robotic device 410 and table area 510, which are depicted as separate child nodes of the node 400. Moreover, because the table area 510 is comprised of multiple objects within a direct or close relationship, the table area node 510 includes the table node 440 and the stacked group node 520. The stacked group node 520 is further comprised of the block nodes 450 and 460 as child nodes.

In either case, the simulation system 170 generates the graph 500 as an electronic data structure stored in the memory 210. The graph 500 generally serves as a means of storing information (e.g., characteristics, subsequent states 260, etc.) about the environment 400. Accordingly, as the simulation system 170 acquires the state information 250 and generates the simulation including the predicted subsequent states 260, the graph 500 at each separate node can be populated with relevant information. For example, the nodes may include identifying characteristics of the objects, coordinates in 3D space for the objects, motion information, and so on.

By way of example, the simulation system 170 populates the graph 500 as the capture module 220 captures the state information 250 and identifies objects therefrom. Thus, as part of executing image recognition, motion tracking, and other routines over the acquired dataset, the capture module 220 analyzes and segments information that is stored within nodes of the graph 500. Moreover, as the simulation module 230 generates the simulation and the predicted subsequent states 260 for the objects (e.g., blocks 450 and 460), the information can be stored within the nodes of the graph.

In either case, consider that the robotic device 410 implements the simulation system 170 and other systems similar to those illustrated with the vehicle 100. Thus, the capture module 220 initially acquires information about the blocks 450 and 460 using the cameras 420 and 430 and camera 126 within the robotic device 410. From this information, the capture module 220 identifies the blocks 450 and 460 and tracks the blocks 450 and 460 using the fiducial markers as processed according to one or more motion capture techniques as may be known. Thus, the simulation module 230 can then generate the simulation along with a predicted subsequent state for the blocks 450 and 460 that is output to, for example, the autonomous module 160.

Thereafter, the simulation module 230 can simulate dynamic behaviors of the blocks 450 and 460 according to planned actions of the robotic device 410, updated state information 250, and so on. Thus, by way of example, the simulation module 230 may simulate movements of the blocks 450 and 460 according to the robotic device 410 lifting the block 450 as planned by the module 160. The simulation and associated predicted subsequent states 260 can include the simulation module 230 predicting a manner in which the block 460 may fall to the floor when the robotic device is lifting the block 450. In this way, the robotic device 410 may anticipate whether the block 460 is about to fall and anticipate movements to prevent the fall. Moreover, as a further example, the simulation module 230 can provide persistent updates for the block 460 if the block is unobserved after falling under the table 440 out of a field-of-view of the robotic device 410 and the cameras 420, 430.

Moreover, if dynamic behaviors of the block 460 differ from the predicted subsequent states 260 (e.g., falls when not expected to fall, or falls in an unexpected manner), the simulation module 230 can identify the discrepancies by comparing the predicted subsequent states 260 with the perceived subsequent state information 250. Thus, as previously disclosed, the simulation module 230 can use the identified differences to improve the simulation model 270 for subsequent predictions.

FIG. 1 will now be discussed in full detail as an example environment within which the system and methods disclosed herein may operate. In some instances, the vehicle 100 is configured to switch selectively between an autonomous mode, one or more semi-autonomous operational modes, and/or a manual mode. Such switching can be implemented in a suitable manner, now known or later developed. “Manual mode” means that all of or a majority of the navigation and/or maneuvering of the vehicle is performed according to inputs received from a user (e.g., human driver). In one or more arrangements, the vehicle 100 can be a conventional vehicle that is configured to operate in only a manual mode.

In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangements, the map data 116 can include one or more terrain maps 117. The terrain map(s) 117 can include information about the ground, terrain, roads, surfaces, and/or other features of one or more geographic areas. The terrain map(s) 117 can include elevation data in the one or more geographic areas. The map data 116 can be high quality and/or highly detailed. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120. As an additional note, while the sensor data 119 is discussed separately from the state information 250, in one or more embodiments, the sensor data 119 and the state information 250 are the same electronic data stored in different storage locations or are stored together in a single repository.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself. In one or more arrangements, the vehicle sensor(s) 121 can be configured to detect, and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect, and/or sense one or more characteristics of the vehicle 100. In one or more arrangements, the vehicle sensor(s) 121 can include a speedometer to determine a current speed of the vehicle 100.

Alternatively, or in addition, the sensor system 120 can include one or more environment sensors 122 configured to acquire, and/or sense driving environment data. “Driving environment data” includes data or information about the external environment in which an autonomous vehicle is located or one or more portions thereof. For example, the one or more environment sensors 122 can be configured to detect, quantify and/or sense obstacles in at least a portion of the external environment of the vehicle 100 and/or information/data about such obstacles. Such obstacles may be stationary objects and/or dynamic objects. The one or more environment sensors 122 can be configured to detect, measure, quantify and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more radar sensors 123, one or more LIDAR sensors 124, one or more sonar sensors 125, and/or one or more cameras 126. In one or more arrangements, the one or more cameras 126 can be high dynamic range (HDR) cameras or infrared (IR) cameras.

The vehicle 100 can include an input system 130. An “input system” includes any device, component, system, element or arrangement or groups thereof that enable information/data to be entered into a machine. The input system 130 can receive an input from a vehicle passenger (e.g., a driver or a passenger). The vehicle 100 can include an output system 135. An “output system” includes any device, component, or arrangement or groups thereof that enable information/data to be presented to a vehicle passenger (e.g., a person, a vehicle passenger, etc.).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system or a geolocation system.

The processor(s) 110, the simulation system 170, and/or the autonomous driving module(s) 160 can be operatively connected to communicate with the various vehicle systems 140 and/or individual components thereof. For example, returning to FIG. 1, the processor(s) 110 and/or the autonomous driving module(s) 160 can be in communication to send and/or receive information from the various vehicle systems 140 to control the movement, speed, maneuvering, heading, direction, etc. of the vehicle 100. The processor(s) 110, the simulation system 170, and/or the autonomous driving module(s) 160 may control some or all of these vehicle systems 140 and, thus, may be partially or fully autonomous.

The processor(s) 110, the simulation system 170, and/or the autonomous driving module(s) 160 can be operatively connected to communicate with the various vehicle systems 140 and/or individual components thereof. For example, returning to FIG. 1, the processor(s) 110, the simulation system 170, and/or the autonomous driving module(s) 160 can be in communication to send and/or receive information from the various vehicle systems 140 to control the movement, speed, maneuvering, heading, direction, etc. of the vehicle 100. The processor(s) 110, the simulation system 170, and/or the autonomous driving module(s) 160 may control some or all of these vehicle systems 140.

The processor(s) 110, the simulation system 170, and/or the autonomous driving module(s) 160 may be operable to control the navigation and/or maneuvering of the vehicle 100 by controlling one or more of the vehicle systems 140 and/or components thereof. For instance, when operating in an autonomous mode, the processor(s) 110, the simulation system 170, and/or the autonomous driving module(s) 160 can control the direction and/or speed of the vehicle 100. The processor(s) 110, the simulation system 170, and/or the autonomous driving module(s) 160 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be any element or combination of elements operable to modify, adjust and/or alter one or more of the vehicle systems 140 or components thereof to responsive to receiving signals or other inputs from the processor(s) 110 and/or the autonomous driving module(s) 160. Any suitable actuator can be used. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more autonomous driving modules 160. The autonomous driving module(s) 160 can be configured to receive data from the sensor system 120 and/or any other type of system capable of capturing information relating to the vehicle 100 and/or the external environment of the vehicle 100. In one or more arrangements, the autonomous driving module(s) 160 can use such data to generate one or more driving scene models. The autonomous driving module(s) 160 can determine position and velocity of the vehicle 100. The autonomous driving module(s) 160 can determine the location of obstacles, objects, or other environmental features including traffic signs, trees, shrubs, neighboring vehicles, pedestrians, etc.

The autonomous driving module(s) 160 can be configured to receive, and/or determine location information for obstacles within the external environment of the vehicle 100 for use by the processor(s) 110, and/or one or more of the modules 160 described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The autonomous driving modules 160 either independently or in combination can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the state information 250 as implemented by the simulation module 230. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The autonomous driving module(s) 160 can be configured to implement determined driving maneuvers. The autonomous driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The autonomous driving module(s) 160 can be configured to execute various vehicle functions and/or to transmit data to, receive data from, interact with, and/or control the vehicle 100 or one or more systems thereof (e.g. one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-5, but the embodiments are not limited to the illustrated structure or application.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™ Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A simulation system for improving predictions about dynamic behaviors within an environment, comprising:
one or more processors;
a memory communicably coupled to the one or more processors and storing:
a capture module including instructions that when executed by the one or more processors cause the one or more processors to capture, using at least one sensor, state information about the environment that is proximate to a observing robotic device, wherein the state information includes data about at least one object that is in the environment; and
a simulation module including instructions that when executed by the one or more processors cause the one or more processors to generate a simulation of the environment according to at least a simulation model and characteristics of the at least one object identified from the state information, wherein the simulation characterizes the at least one object in relation to an inertial frame of the environment around the observing robotic device,
wherein the simulation module further includes instructions to predict a subsequent state for the at least one object within the simulation based, at least in part, on the simulation model, and to provide the subsequent state as an electronic output.

2. The simulation system of claim 1, wherein the capture module includes instructions to, in response to capturing, using the at least one sensor, subsequent information about the environment including the at least one object, compare the subsequent state that was predicted with a perceived state identified within the subsequent information to identify differences between the subsequent state and the perceived state that are indicative of discrepancies in the simulation model.

3. The simulation system of claim 2, wherein the simulation module includes instructions to update the simulation model according to the differences,
wherein the simulation module includes instructions to generate the simulation including instructions to apply the simulation model that includes a subset of models for predicting and characterizing behaviors of aspects of the environment including the at least one object, and wherein the simulation module includes instructions to update the simulation model including instructions to adjust one or more of internal weights of the subset of models and algorithms to improve the simulation.

4. The simulation system of claim 2, wherein the simulation module includes instructions to adjust the simulation of the environment to account for the differences by updating a representation of the at least one object in the simulation to correspond with the perceived state.

5. The simulation system of claim 1, wherein the simulation module includes instructions to, in response to capturing, using the at least one sensor, subsequent information about the environment that does not include an observation of the at least one object, generate a persistent update to the simulation that predicts an unobserved state of the at least one object, wherein generating the persistent update tracks the at least one object when the at least one object is not observed by the at least one sensor and provides for maintaining an awareness about the at least one object by the observing robotic device.

6. The simulation system of claim 1, wherein the capture module includes instructions to analyze the state information to determine characteristics of the at least one object by segmenting the at least one object from the information, localizing the at least one object in the environment, and estimating a pose and a velocity of the at least one object,
wherein the at least one sensor is a camera,
wherein the capture module includes instructions to capture the state information including instructions to control one or more of: onboard sensors within the observing robotic device and infrastructure sensors mounted within the environment, and wherein the capture module includes instructions to capture the state information including instructions to detect a visible fiducial that is marked on the at least one object for tracking the at least one object using the at least one sensor.

7. The simulation system of claim 1, wherein the simulation module includes instructions to generate the simulation including instructions to generate the simulation persistently for the at least one object once initially observed by the at least one sensor, wherein the simulation module includes instructions to generate the simulation including instructions to generate the simulation as physically accurate in comparison to the environment and at time steps that are quicker than real-time to provide for anticipating motion of the at least one object within the environment.

8. The simulation system of claim 1, wherein the observing robotic device is a vehicle.

9. A non-transitory computer-readable medium for improving predictions about dynamic behaviors within an environment and including instructions that when executed by one or more processors cause the one or more processors to:
capture, using at least one sensor, state information about the environment that is proximate to an observing robotic device, wherein the state information includes data about at least one object that is in the environment;
generate a simulation of the environment according to at least a simulation model and characteristics of the at least one object identified from the state information, wherein the simulation characterizes the at least one object in relation to an inertial frame of the environment around the observing robotic device;
predict a subsequent state for the at least one object within the simulation based, at least in part, on the simulation model; and
provide the subsequent state as an electronic output.

10. The non-transitory computer-readable medium of claim 9, wherein the instructions include instructions to, in response to capturing, using the at least one sensor, subsequent information about the environment including the at least one object, compare the subsequent state that was predicted with a perceived state identified within the subsequent information to identify differences between the subsequent state and the perceived state that are indicative of discrepancies in the simulation model.

11. The non-transitory computer-readable medium of claim 10, wherein the instructions include instructions to update the simulation model according to the differences,
wherein the instructions include instructions to generate the simulation including instructions to apply the simulation model that includes a subset of models for predicting and characterizing behaviors of aspects of the environment including the at least one object, and wherein the instructions to update the simulation model include instructions to adjust one or more of internal weights of the subset of models and algorithms to improve the simulation.

12. The non-transitory computer-readable medium of claim 10, wherein the instructions include instructions to adjust the simulation of the environment to account for the differences by updating a representation of the at least one object in the simulation to correspond with the perceived state.

13. The non-transitory computer-readable medium of claim 10, wherein the instructions include instructions to, in response to capturing, using the at least one sensor, subsequent information about the environment that does not include an observation of the at least one object, generate a persistent update to the simulation that predicts an unobserved state of the at least one object, wherein generating the persistent update tracks the at least one object when the at least one object is not observed by the at least one sensor and provides for maintaining an awareness about the at least one object by the observing robotic device.

14. A method for improving a persistent simulation of an environment, the method comprising:
capturing, using at least one sensor, state information about the environment that is proximate to an observing robotic device, wherein the state information includes data about at least one object that is in the environment;
generating a simulation of the environment according to at least a simulation model and characteristics of the at least one object identified from the state information, wherein the simulation is a virtualization of the environment that characterizes the at least one object in relation to an inertial frame of the environment around the observing robotic device;
predicting a subsequent state for the at least one object within the simulation based, at least in part, on the simulation model; and
providing the subsequent state as an electronic output.

15. The method of claim 14, further comprising:
in response to capturing, using the at least one sensor, subsequent information about the environment including the at least one object, comparing the subsequent state that was predicted with a perceived state identified within the subsequent information to identify differences between the subsequent state and the perceived state that are indicative of discrepancies in the simulation model.

16. The method of claim 15, further comprising:
updating the simulation model according to the differences, wherein generating the simulation includes applying the simulation model that includes a subset of models for predicting and characterizing behaviors of aspects of the environment including the at least one object, and wherein updating the simulation model includes adjusting one or more of internal weights of the subset of models and algorithms to improve the simulation.

17. The method of claim 15, further comprising:
adjusting the simulation of the environment to account for the differences by updating a representation of the at least one object in the simulation to correspond with the perceived state.

18. The method of claim 14, further comprising:
in response to capturing, using the at least one sensor, subsequent information about the environment that does not include an observation of the at least one object, generating a persistent update to the simulation that predicts an unobserved state of the at least one object, wherein generating the persistent update tracks the at least one object when the at least one object is not observed by the at least one sensor and provides for maintaining an awareness about the at least one object by the observing robotic device.

19. The method of claim 14, further comprising:
analyzing the state information to determine characteristics of the at least one object by segmenting the at least one object from the information, localizing the at least one object in the environment, and estimating a pose and a velocity of the at least one object,
wherein capturing the state information using the at least one sensor includes capturing images using a camera,
wherein capturing includes controlling one or more of: onboard sensors within the observing robotic device and infrastructure sensors mounted within the environment, and wherein capturing includes detecting a visible fiducial that is marked on the at least one object for tracking using the at least one sensor.

20. The method of claim 14, wherein generating the simulation includes generating the simulation persistently for the at least one object once initially observed by the at least one sensor, wherein generating the simulation includes generating the simulation as physically accurate in comparison to the environment and at time steps that are quicker than real-time to provide for anticipating motion within the environment.
